(19) United States
(12) Patent Application Publication
(10) Pub. No.: US 2025/0340213 A1
(43) Pub. Date: Nov. 6, 2025

(54) DEADLOCK RECOVERY

(71) Applicant: Honda Motor Co., Ltd., Tokyo (JP)

(72) Inventors: Francesca BALDINI, San Jose, CA (US); Faizan M. TARIQ, San Jose, CA (US); Sangjae BAE, San Jose, CA (US); David Francis ISELE, Sunnyvale, CA (US)

(21) Appl. No.: 19/068,565

(22) Filed: Mar. 3, 2025

Related U.S. Application Data
(60) Provisional application No. 63/641,287, filed on May 1, 2024.

(51) Int. Cl. B60W 60/00

(52) U.S. Cl. CPC B60W 60/001

(57) ABSTRACT

According to one aspect, deadlock recovery may include generating an initial path for an autonomous vehicle (AV) based on lane information, traffic information, and spatial constraints, generating a signal temporal logic (STL) evaluation based on one or more STL rules, generating an AV command based on the initial path, the STL evaluation, and a cost function, and operating the AV in an autonomous mode according to the AV command.

### CROSS-REFERENCE TO RELATED APPLICATIONS

This application claims the benefit of U.S. Provisional Patent Application, Ser. No. 63/641,287 (Attorney Docket No. H1241110US01) entitled “DEADLOCK RECOVERY APPROACH”, filed on May 1, 2024; the entirety of the above-noted application(s) is incorporated by reference herein.

### BACKGROUND

When multiple agents share a space, interactions between agents may lead to deadlocks, where no agent may advance toward their goal. Deadlocks, such as vehicles heading in opposite directions through a narrow passage, produce challenging problems that may be difficult for human drivers and autonomous vehicles to resolve. These situations, which require intricate agent prediction, routing and rerouting strategies, and navigation through expanded dynamic spaces, make resolving deadlocks a complex issue for automated vehicle (AV) technology.

This presents concerns for traffic flow, especially in urban settings where real-time decision-making is important and where AVs must coexist with human-driven vehicles, each relying on distinct decision-making processes. While human-driven vehicles navigate such situations through human judgement and gesturing, AVs may not have the same human judgement.

### BRIEF DESCRIPTION

According to one aspect, a system for deadlock recovery may include a memory and a processor. The memory may store one or more instructions. The processor may execute one or more of the instructions stored on the memory to perform one or more acts, actions, and/or steps. For example, the processor may generate an initial path for an autonomous vehicle (AV) based on lane information, traffic information, and spatial constraints, generate a signal temporal logic (STL) evaluation based on one or more STL rules, generate an AV command based on the initial path, the STL evaluation, and a cost function, and operate the AV in an autonomous mode according to the AV command.

The generating the initial path, the generating the STL evaluation, and the generating the AV command may be responsive to detecting a deadlock condition. The generating the initial path may be performed by a hybrid A planner. The cost function may be a Model Predictive Path Integral (MPPI) cost function and an MPPI controller performs the generating the AV command. One or more of the STL rules may include a spatial constraint, a traffic rule, or a hardware constraint associated with the AV. One or more of the STL rules may include a following distance, a lane keeping rule, a lane change rule, an intersection approach rule, a deadlock timeout rule, or a jerk rule. The generating the STL evaluation may be based on AV information, lane information, and traffic information. The STL evaluation may be generated based on weighting one or more of the STL rules. The AV information may include a state of the AV and a control input associated with the AV. The AV command may be generated over a time horizon.

According to one aspect, a computer-implemented method for deadlock recovery may include generating an initial path for an autonomous vehicle (AV) based on lane information, traffic information, and spatial constraints, generating a signal temporal logic (STL) evaluation based on one or more STL rules, generating an AV command based on the initial path, the STL evaluation, and a cost function, and operating the AV in an autonomous mode according to the AV command.

The generating the initial path, the generating the STL evaluation, and the generating the AV command may be responsive to detecting a deadlock condition. The generating the initial path may be performed by a hybrid A planner. The cost function may be a Model Predictive Path Integral (MPPI) cost function and an MPPI controller performs the generating the AV command. One or more of the STL rules may include a spatial constraint, a traffic rule, or a hardware constraint associated with the AV.

According to one aspect, an autonomous vehicle (AV) capable of deadlock recovery may include a processor, a memory, and a Model Predictive Path Integral (MPPI) controller. The memory may store one or more instructions. The processor may execute one or more of the instructions stored on the memory to perform one or more acts, actions, and/or steps. For example, the processor may generate an initial path for an autonomous vehicle (AV) based on lane information, traffic information, and spatial constraints and generate a signal temporal logic (STL) evaluation based on one or more STL rules. The MPPI controller may generate an AV command based on the initial path, the STL evaluation, and an MPPI cost function and operate the AV in an autonomous mode according to the AV command.

The generating the initial path, the generating the STL evaluation, and the generating the AV command may be responsive to detecting a deadlock condition. The generating the initial path may be performed by a hybrid A planner. One or more of the STL rules may include a spatial constraint, a traffic rule, or a hardware constraint associated with the AV. One or more of the STL rules may include a following distance, a lane keeping rule, a lane change rule, an intersection approach rule, a deadlock timeout rule, or a jerk rule.

### BRIEF DESCRIPTION OF THE DRAWINGS

FIG. 1 is an exemplary component diagram of a system for deadlock recovery, according to one aspect.

FIG. 2 is an exemplary flow diagram of a computer-implemented method for deadlock recovery, according to one aspect.

FIG. 3 is an exemplary architecture of the system for deadlock recovery of FIG. 1, according to one aspect.

FIG. 4 is an exemplary table of signal temporal logic rules associated with the system for deadlock recovery of FIG. 1 and the computer-implemented method for deadlock recovery of FIG. 2, according to one aspect.

FIGS. 5A-5D are exemplary scenarios associated with deadlock recovery, according to one aspect.

FIG. 6 is an illustration of an example computing environment where one or more of the provisions set forth herein are implemented, according to one aspect.

FIG. 7 is an illustration of an example computer-readable medium or computer-readable device including processor-executable instructions configured to embody one or more of the provisions set forth herein, according to one aspect.

### DETAILED DESCRIPTION

The following includes definitions of selected terms employed herein. The definitions include various examples and/or forms of components that fall within the scope of a term and that may be used for implementation. The examples are not intended to be limiting. Further, one having ordinary skill in the art will appreciate that the components discussed herein, may be combined, omitted, or organized with other components or organized into different architectures.

A “deadlock”, as used herein, may be defined as any condition where a vehicle, due to conflicting goals or physical obstructions, finds itself unable to move forward.

A “processor”, as used herein, processes signals and performs general computing and arithmetic functions. Signals processed by the processor may include digital signals, data signals, computer instructions, processor instructions, messages, a bit, a bit stream, or other means that may be received, transmitted, and/or detected. Generally, the processor may be a variety of various processors including multiple single and multicore processors and co-processors and other multiple single and multicore processor and co-processor architectures. The processor may include various modules to execute various functions.

A “memory”, as used herein, may include volatile memory and/or non-volatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

A “disk” or “drive”, as used herein, may be a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD-ROM). The disk may store an operating system that controls or allocates resources of a computing device.

A “bus”, as used herein, refers to an interconnected architecture that is operably connected to other computer components inside a computer or between computers. The bus may transfer data between the computer components. The bus may be a memory bus, a memory controller, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect Network (LIN), among others.

A “database”, as used herein, may refer to a table, a set of tables, and a set of data stores (e.g., disks) and/or methods for accessing and/or manipulating those data stores.

An “operable connection”, or a connection by which entities are “operably connected”, is one in which signals, physical communications, and/or logical communications may be sent and/or received. An operable connection may include a wireless interface, a physical interface, a data interface, and/or an electrical interface.

A “computer communication”, as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

A “mobile device”, as used herein, may be a computing device typically having a display screen with a user input (e.g., touch, keyboard) and a processor for computing. Mobile devices include handheld devices, portable electronic devices, smart phones, laptops, tablets, and e-readers.

A “vehicle”, as used herein, refers to any moving vehicle that is capable of carrying one or more human occupants and is powered by any form of energy. The term “vehicle” includes cars, trucks, vans, minivans, SUVs, motorcycles, scooters, boats, personal watercraft, and aircraft. In some scenarios, a motor vehicle includes one or more engines. Further, the term “vehicle” may refer to an electric vehicle (EV) that is powered entirely or partially by one or more electric motors powered by an electric battery. The EV may include battery electric vehicles (BEV) and plug-in hybrid electric vehicles (PHEV). Additionally, the term “vehicle” may refer to an autonomous vehicle and/or self-driving vehicle powered by any form of energy. The autonomous vehicle may or may not carry one or more human occupants.

A “vehicle system”, as used herein, may be any automatic or manual systems that may be used to enhance the vehicle, and/or driving. Exemplary vehicle systems include an autonomous driving system, an electronic stability control system, an anti-lock brake system, a brake assist system, an automatic brake prefill system, a low speed follow system, a cruise control system, a collision warning system, a collision mitigation braking system, an auto cruise control system, a lane departure warning system, a blind spot indicator system, a lane keep assist system, a navigation system, a transmission system, brake pedal systems, an electronic power steering system, visual devices (e.g., camera systems, proximity sensor systems), a climate control system, an electronic pretensioning system, a monitoring system, a passenger detection system, a vehicle suspension system, a vehicle seat configuration system, a vehicle cabin lighting system, an audio system, a sensory system, among others.

An “agent”, as used herein, may be a machine that moves through or manipulates an environment, which may be a real-world environment or a simulated environment. Exemplary agents may include robots, vehicles, or other self-propelled machines. The agent may be autonomously, semi-autonomously, or manually operated.

A deadlock recovery strategy is disclosed herein as a system for deadlock recovery and a computer-implemented method for deadlock recovery. In particular, a proposed algorithm for the deadlock recovery strategy integrates a hybrid-A* planner, signal temporal logic (STL), and a Model Predictive Path Integral (MPPI) controller. The hybrid-A* planner may generate a reference path, the STL may be utilized to define a goal (e.g., deadlock avoidance) and constraints with regard to traffic rules, etc., and the MPPI controller may refine the path and speed accordingly. This STL-MPPI framework ensures the system for deadlock recovery compliance of the resulting maneuvers, indicating a strong potential for complex traffic scenarios (and rules) in practice, thereby providing the benefit of efficient and robust deadlock recovery.

The deadlock recovery framework described herein enables real-time regeneration of vehicle paths while maintaining desired thresholds for any maneuvers. The planner may generate non-holonomic paths that adhere to the dynamic capabilities of the AV and comply with spatial and environmental constraints. To ensure the efficient execution of operations to disengage from deadlock, a strategy to combine STL predicates with the MPPI controller may be implemented. This integration may leverage stochastic sampling to provide the benefit and advantage of significantly reducing the computational demands typically associated with other control methods, such as model predictive control (MPC), thereby enhancing efficiency and compliance with traffic laws during deadlock recovery.

Signal temporal logic (STL) is a formalism used to specify properties of trajectories in a way that allows for the precise definition of temporal and logical constraints. In the context of autonomous driving, STL may be employed to describe desired behaviors of the vehicle over time, such as margins, thresholds, speed limits, and temporal constraints on actions. A Model Predictive Path Integral (MPPI) controller optimization-based control strategy may use stochastic sampling to generate a distribution of possible future trajectories, evaluate them based on a cost function, and select an optimal path to follow. This approach may be useful in dynamic and uncertain environments, making it suitable for handling complex scenarios like deadlock recovery. Thus, combining STL for specification with MPPI for control may provide a robust framework for deadlock recovery in autonomous driving by ensuring that the vehicle not only follows the optimal path to recover from deadlock situations but also adheres to the specified thresholds and temporal constraints needed.

By integrating STL with MPPI control within the framework, this enhances the AV's ability to navigate complex traffic scenarios. The contributions include a hybrid approach that leverages the robustness of MPPI in handling uncertainties with the precise constraint enforcement capabilities of STL. This dual framework allows for the benefit and advantage of real-time adherence to dynamic thresholds and operational constraints.

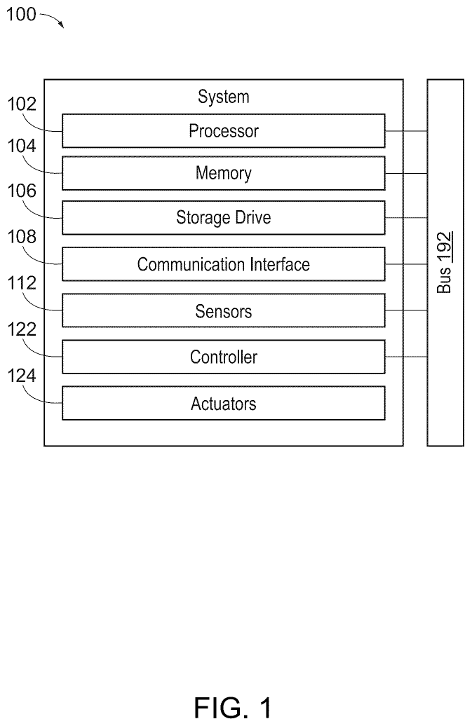

FIG. 1 is an exemplary component diagram of a system 100 for deadlock recovery, according to one aspect. The system 100 for deadlock recovery may be implemented on an autonomous vehicle, according to one aspect. For example, the system 100 for deadlock recovery may include a processor 102, a memory 104, a storage drive 106, a communication interface 108, one or more sensors 112, a controller (e.g., a Model Predictive Path Integral (MPPI) controller), one or more actuators 124, and a bus 192. The bus 192 may form operable connections between or communicatively couple one or more of the components (e.g., the processor 102, the memory 104, the storage drive 106, the communication interface 108, one or more of the sensors 112, the MPPI controller 122, one or more of the actuators 124) of the system 100 for deadlock recovery and enable computer communication therebetween.

The memory 104 may store one or more instructions. The processor 102 may execute one or more of the instructions stored on the memory 104 to perform one or more acts, actions, and/or steps. According to one aspect, the MPPI controller 122 may be implemented via the processor 102, the memory 104, the storage drive 106, etc. According to another aspect, the MPPI controller 122 may include its own processor 102, memory 104, storage drive 106, etc.

One or more of the sensors 112 may detect traffic information from an external environment or a real-world environment through which an autonomous vehicle (AV) is travelling. According to one aspect, the processor 102 may determine a deadlock condition based on the detected traffic information.

The deadlock recovery problem may be defined by the processor 102 as:

Given the initial state of an ego-vehicle

$${x}_{0}^{ego}$$

(e.g., the AV), Its dynamical constraints, the current state of other vehicles

$${x}_{curr}^{i}$$

and traffic rules, a goal may be to find a sequence of control inputs uₜ={u₁, u₂, . . . , uₙ} to transition the vehicle from

$${x}_{0}^{ego}$$

to its goal position

$${x}_{T}^{ego}$$

to recover from the deadlock while avoiding collisions with obstacles, and complying with traffic laws.

To solve the problem, the processor 102 may: (i) detect of deadlock conditions, and (ii) receive list of traffic laws to adhere and threshold constraints to adhere. According to one aspect, the processor 102 may receive the list of traffic laws via the communication interface 108 and store the traffic laws on the storage drive 106.

Deadlock Conditions: aligned with the definition described herein, the ego-vehicle may be defined to be in a deadlock situation when the ego-vehicle is unable to continue on its intended path or reaching its destination.

Deadlock scenarios may arise from situations where multiple agents, including vehicles and pedestrians, obstruct each other's progress, creating a standstill where no participant may advance without the cooperation or movement of others. According to one aspect, in certain deadlock scenarios, the processor 102 may evaluate other agents' behaviors reactive to the ego-vehicle's actions.

### Hybrid a Planner

The processor 102 may generate an initial path for the AV based on lane information, traffic information, and spatial constraints. The generating the initial path may be responsive to detecting a deadlock condition. The generating the initial path may be performed by a hybrid A planner.

### Signal Temporal Logic (STL)

The processor 102 may generate an STL evaluation based on one or more STL rules. The generating the STL evaluation may be responsive to detecting the deadlock condition. One or more of the STL rules may include a spatial constraint, a traffic rule, or a hardware constraint associated with the AV. One or more of the STL rules may include a following distance, a lane keeping rule, a lane change rule, an intersection approach rule, a deadlock timeout rule, or a jerk rule.

The generating the STL evaluation may be based on AV information, lane information, and traffic information. The STL evaluation may be generated based on weighting one or more of the STL rules. The AV information may include a state of the AV and a control input associated with the AV. The AV command may be generated over a time horizon.

In this way, the processor 102 may utilize STL to formally define and enforce threshold margins, speed limits, and other critical temporal constraints within the control framework. This ensures that any vehicle maneuvers adhere to predefined standards even under uncertain conditions and narrowed areas.

### Model Predictive Path Integral (MPPI) Controller

The MPPI controller 122 may generate an AV command based on the initial path, the STL evaluation, and a cost function. The generating the AV command may be responsive to detecting the deadlock condition. The cost function may be a Model Predictive Path Integral (MPPI) cost function and the MPPI controller 122 may perform the generating the AV command.

The MPPI controller 122 may operate the AV in an autonomous mode according to the AV command. The MPPI controller 122 may operate the AV using one or more of the actuators 124 to implement a steering command, a throttle command, a velocity command, etc. associated with the AV command. In this way, the AV command may include the steering command, the throttle command, the velocity command, etc.

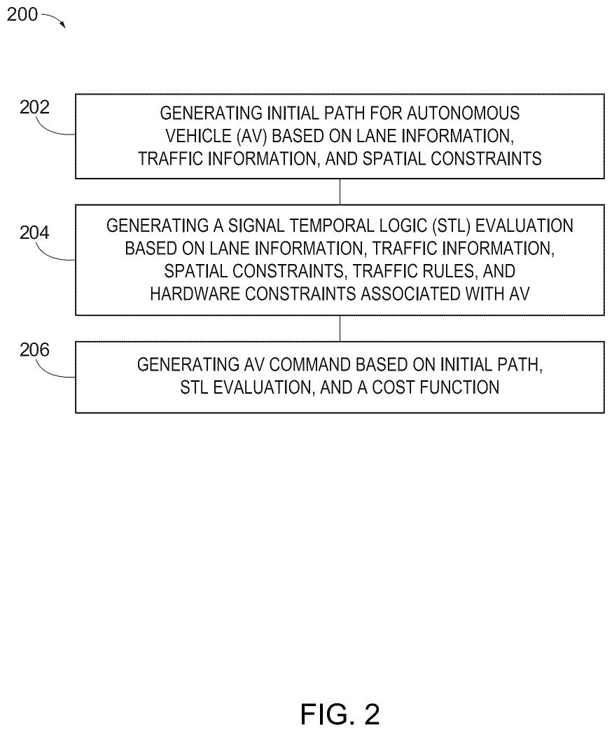

FIG. 2 is an exemplary flow diagram of a computer-implemented method 200 for deadlock recovery, according to one aspect. For example, the computer-implemented method for deadlock recovery may include generating 202 an initial path for an autonomous vehicle (AV) based on lane information, traffic information, and spatial constraints, generating 204 a signal temporal logic (STL) evaluation based on one or more STL rules, generating 206 an AV command based on the initial path, the STL evaluation, and a cost function, and operating the AV in an autonomous mode according to the AV command.

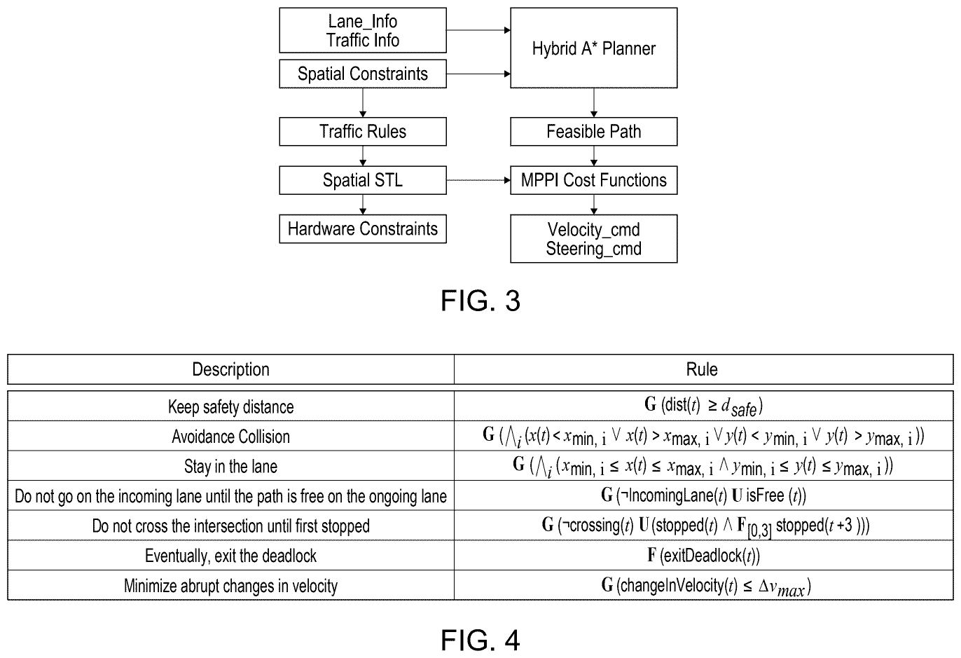

FIG. 3 is an exemplary architecture of the system 100 for deadlock recovery of FIG. 1, according to one aspect. FIG. 3 illustrates the overall pipeline of the STL-MPPI framework. Overall, STL-MPPI refines control inputs to minimize a cost function. The cost function balances the goal achievement (e.g., recovery) and adherence to thresholds and constraints governed by STL.

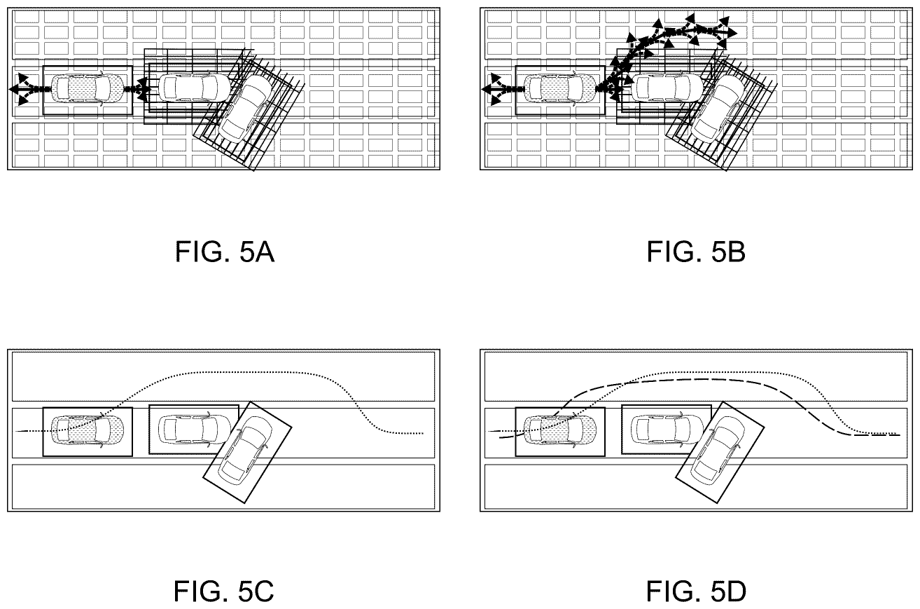

The process begins with a modified version of the Hybrid A* planner that crafts a feasible initial path t, considering both vehicle dynamics and environmental constraints as illustrated in FIGS. 5A-5D. This path is then refined through the STL-MPPI.

Signal Temporal Logic (STL): the processor 102 may employ STL to adhere to traffic rules and constraints for the ego-vehicle, specifying temporal properties of a desired trajectory. For a signal xₜ, where tϵ [symbol] _{≥0} represents time, an STL formula ϕ may be defined recursively as follows:

$$Φ : : = T \vert f ( x ) > 0 \vert ¬ ϕ \vert ϕ ∧ ψ \vert {F}_{[ a , b ]} ϕ \vert {G}_{[ a , b ]} ϕ \vert ϕ {U}_{[ a , b ]} ψ \qquad ( 1 )$$

where:
T signifies a condition that is always true;
f(x)>0 denotes an atomic proposition defined by a function ff of the signal xₜ;
¬, ∧, F, G, and U represent negation, conjunction, future, globally, and until operators, respectively; and
a, bϵ [symbol] _{≥0}, with a≤b, specify the time interval for temporal operators.

STL specifications Φ for deadlock recovery encompass threshold constraints, such as maintaining a desired threshold distance from other vehicles G_{[0,T]}(d(xₜ)≥d_{safe}), where d(xₜ) denotes the distance to the nearest vehicle and d_{safe} represents a predetermined desired threshold distance. The processor 102 may consider temporal properties, such as stopping at intersections as mandated by road rules (F_{[0,T]} stop at intersection), and liveness properties, like eventually leaving the deadlock zone (F_{[0,T]} outside deadlock zone).

STL-MPPI: To integrate STL into the MPPI framework, the processor 102 may implement penalty functions for violations of STL criteria within the cost function. These penalties [symbol] _{ϕ}(xₜ, t) escalate the cost for any breach of STL specifications, steering the optimization process toward solutions that align with predetermined behavioral norms.

The MPPI controller 122 may optimize control inputs over a finite horizon to minimize a cost function, which incorporates the trajectory's performance and compliance with STL specifications. The optimization challenge under the STL-MPPI framework may be defined as:

$${min}_{{\{ {u}_{t} \}}_{t = 0}^{T - 1}} E [ {\sum }_{t = 0}^{T - 1} L ( {x}_{t} , {u}_{t} ) + Φ ( {x}_{T} ) + {\sum }_{ϕ ∈ Φ} {W}_{ϕ} {I}_{ϕ} ( {x}_{t} ) ] \qquad ( 2 )$$

where:
xₜ and uₜ are the state and control input of the vehicle at time t, respectively;
T is the optimization time horizon;
L(xₜ), uₜ, t is the running cost at time t, including terms for tracking a reference path;
Φ(x_{T}) is the terminal cost, reflecting the desirability of the final state;
ϕ is a set of STL specifications relevant to deadlock recovery;
W_{ϕ} are weights reflecting the importance of satisfying each STL specification ϕ; and
[symbol] _{ϕ}(xₜ, t) is a penalty function for the violation of STL specification ϕ at time t, defined based on the robustness metric of STL.

The MPPI algorithm evaluates various control sequences uₖ, projecting the vehicle's path over the forecast horizon T. The cost for each projected trajectory τₖ is calculated as:

$$J ( {τ}_{k} ) = {\sum }_{t = 0}^{T} L ( {x}_{t} , {u}_{t} ) + δΦ ( {x}_{T} ) + μ {I}_{ϕ} ( {τ}_{k} ) \qquad ( 3 )$$

where:
L(xₜ, uₜ) denotes the running cost at time t for the state xₜ and control input uₜ;
Φ(x_{T}) represents the terminal cost, with δ acting as a scaling factor; and
I_{ϕ}(τₖ) imposes penalties for any violations of STL specifications, scaled by μ.

For a trajectory τₖ, the STL evaluation augments the cost function with penalties for violating STL constraints:

$${I}_{ϕ} ( {τ}_{k} ) = \{ \begin{matrix}0 , & if {τ}_{k} satisfies ϕ , \\ penalty , & otherwise .\end{matrix} \qquad ( 4 )$$

The optimal trajectory is chosen based on the computed costs. Evaluate and assign weights to trajectories k according to their associated costs, giving preference to paths with lower costs, as determined by:

$${w}_{k} = \frac{exp ( - \frac{1}{λ} J ( {τ}_{k} ) )}{{\sum }_{j = 1}^{K} exp ( - \frac{1}{λ} J ( {τ}_{j} ) )} \qquad ( 5 )$$

where λ acts as the temperature parameter that regulates the distribution of weights among the trajectories. This mechanism selects the optimal trajectory that minimizes the cost function while meeting STL constraints, thereby ensuring efficient navigation of the vehicle to its destination.

The sampling of control sequences uₖ within the STLMPPI algorithm is guided by a distribution centered around the current best estimate of the control sequence. The sampled control sequences are perturbed versions of this estimate, enabling the exploration of the control space to identify a sequence that minimizes the expected cost. The formula for generating these samples is as follows:

$${u}_{k} ( t ) = {\overline{u}}_{t} + {ϵ}_{{k}_{t}} , {ϵ}_{{k}_{t}} ∼ 𝒩 ( 0 , \sum ) \qquad ( 6 )$$

where:
ūₜ represents the current best estimate of the control at time t; and
ϵₖ_{ₜ} is a perturbation added to the control signal, sampled from a Gaussian distribution with mean 00 and covariance Σ.

This approach enables the MPPI controller 122 to iteratively refine the control sequence by evaluating a diverse set of trajectories and selecting the one that offers the best balance between performance and compliance with the specified constraints.

FIG. 4 is an exemplary table of signal temporal logic rules associated with the system 100 for deadlock recovery of FIG. 1 and the computer-implemented method for deadlock recovery of FIG. 2, according to one aspect. FIG. 4 illustrates a table of exemplary rules considered. These rules may be extended for more dynamic environments.

FIGS. 5A-5D are exemplary scenarios associated with deadlock recovery, according to one aspect. As seen in FIGS. 5A-5B, the navigable space in the environment may be discretized by the processor into sparse grids along the lanes and finer grids around obstacles. This approach ensures that even in tighter spaces, a feasible path may be always available. The Hybrid A* planner and/or algorithm may generate a feasible path for vehicles by adhering to vehicle dynamics and spatial constraints, such as staying within lane boundaries and maintaining safe distances from obstacles. After the Hybrid A* planner and/or algorithm creates an initial path (e.g., as seen in FIG. 5C), the STL-MPPI controller may dynamically generate a velocity and steering profile that results in a new path (e.g., as seen in FIG. 5D), aligning with spatiotemporal constraints and hardware specifications.

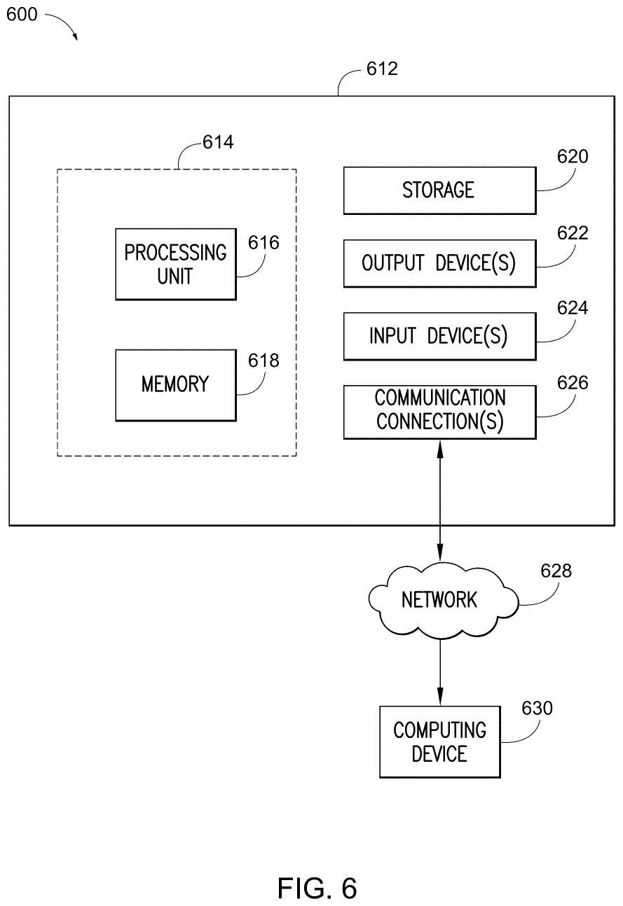

FIG. 6 and the following discussion provide a description of a suitable computing environment to implement aspects of one or more of the provisions set forth herein. The operating environment of FIG. 6 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 6 illustrates a system 600 including a computing device 612 configured to implement one aspect provided herein. In one configuration, the computing device 612 includes at least one processing unit 616 and memory 618. Depending on the exact configuration and type of computing device, memory 618 may be volatile, such as RAM, non-volatile, such as ROM, flash memory, etc., or a combination of the two. This configuration is illustrated in FIG. 6 by dashed line 614.

In other aspects, the computing device 612 includes additional features or functionality. For example, the computing device 612 may include additional storage such as removable storage or non-removable storage, including, but not limited to, magnetic storage, optical storage, etc. Such additional storage is illustrated in FIG. 6 by storage 620. In one aspect, computer readable instructions to implement one aspect provided herein are in storage 620. Storage 620 may store other computer readable instructions to implement an operating system, an application program, etc. Computer readable instructions may be loaded in memory 618 for execution by the at least one processing unit 616, for example.

The term “computer readable media” as used herein includes computer storage media. Computer storage media includes volatile and nonvolatile, removable, and non-removable media implemented in any method or technology for storage of information such as computer readable instructions or other data. Memory 618 and storage 620 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the computing device 612. Any such computer storage media is part of the computing device 612.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The computing device 612 includes input device(s) 624 such as keyboard, mouse, pen, voice input device, touch input device, infrared cameras, video input devices, or any other input device. Output device(s) 622 such as one or more displays, speakers, printers, or any other output device may be included with the computing device 612. Input device(s) 624 and output device(s) 622 may be connected to the computing device 612 via a wired connection, wireless connection, or any combination thereof. In one aspect, an input device or an output device from another computing device may be used as input device(s) 624 or output device(s) 622 for the computing device 612. The computing device 612 may include communication connection(s) 626 to facilitate communications with one or more other devices 630, such as through network 628, for example.

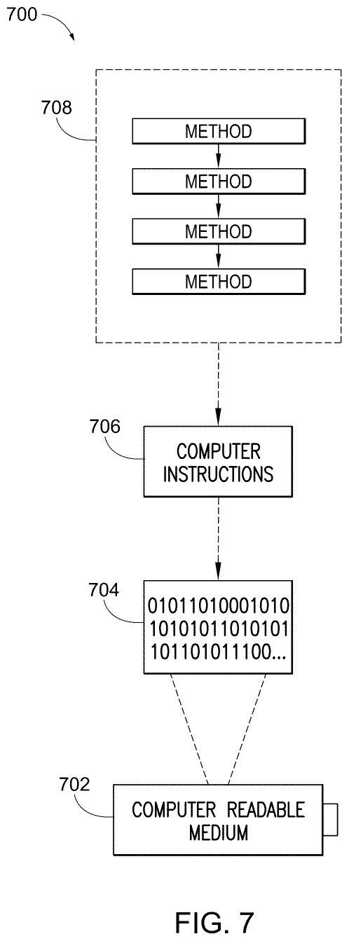

Still another aspect involves a computer-readable medium including processor-executable instructions configured to implement one aspect of the techniques presented herein. An aspect of a computer-readable medium or a computer-readable device devised in these ways is illustrated in FIG. 7, wherein an implementation 700 includes a computer-readable medium 702, such as a CD-R, DVD-R, flash drive, a platter of a hard disk drive, etc., on which is encoded computer-readable data 704. This encoded computer-readable data 704, such as binary data including a plurality of zero's and one's as shown in 704, in turn includes a set of processor-executable computer instructions 706 configured to operate according to one or more of the principles set forth herein. In this implementation 700, the processor-executable computer instructions 706 may be configured to perform a method 708, such as the computer-implemented method 200 for deadlock recovery of FIG. 2. In another aspect, the processor-executable computer instructions 706 may be configured to implement a system, such as the system 100 for deadlock recovery of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Although the subject matter has been described in language specific to structural features or methodological acts, it is to be understood that the subject matter of the appended claims is not necessarily limited to the specific features or acts described above. Rather, the specific features and acts described above are disclosed as example aspects.

Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various of the above-disclosed and other features and functions, or alternatives or varieties thereof, may be desirably combined into many other different systems or applications. Also, that various presently unforeseen or unanticipated alternatives, modifications, variations, or improvements therein may be subsequently made by those skilled in the art which are also intended to be encompassed by the following claims.

1. A system for deadlock recovery, comprising:
a memory storing one or more instructions;
a processor executing one or more of the instructions stored on the memory to perform:
generating an initial path for an autonomous vehicle (AV) based on lane information, traffic information, and spatial constraints;
generating a signal temporal logic (STL) evaluation based on one or more STL rules;
generating an AV command based on the initial path, the STL evaluation, and a cost function; and
operating the AV in an autonomous mode according to the AV command.

2. The system for deadlock recovery of claim 1, wherein the cost function is a Model Predictive Path Integral (MPPI) cost function and an MPPI controller performs the generating the AV command.

3. The system for deadlock recovery of claim 1, wherein the generating the initial path, the generating the STL evaluation, and the generating the AV command is responsive to detecting a deadlock condition.

4. The system for deadlock recovery of claim 1, wherein the generating the initial path is performed by a hybrid A planner.

5. The system for deadlock recovery of claim 1, wherein one or more of the STL rules includes a spatial constraint, a traffic rule, or a hardware constraint associated with the AV.

6. The system for deadlock recovery of claim 1, wherein one or more of the STL rules includes a following distance, a lane keeping rule, a lane change rule, an intersection approach rule, a deadlock timeout rule, or a jerk rule.

7. The system for deadlock recovery of claim 1, wherein the generating the STL evaluation is based on AV information, lane information, and traffic information.

8. The system for deadlock recovery of claim 7, wherein the AV information includes a state of the AV and a control input associated with the AV.

9. The system for deadlock recovery of claim 1, wherein the AV command is generated over a time horizon.

10. The system for deadlock recovery of claim 1, wherein the STL evaluation is generated based on weighting one or more of the STL rules.

11. A computer-implemented method for deadlock recovery, comprising:
generating an initial path for an autonomous vehicle (AV) based on lane information, traffic information, and spatial constraints;
generating a signal temporal logic (STL) evaluation based on one or more STL rules;
generating an AV command based on the initial path, the STL evaluation, and a cost function; and
operating the AV in an autonomous mode according to the AV command.

12. The computer-implemented method for deadlock recovery of claim 11, wherein the cost function is a Model Predictive Path Integral (MPPI) cost function and an MPPI controller performs the generating the AV command.

13. The computer-implemented method for deadlock recovery of claim 11, wherein the generating the initial path, the generating the STL evaluation, and the generating the AV command is responsive to detecting a deadlock condition.

14. The computer-implemented method for deadlock recovery of claim 11, wherein the generating the initial path is performed by a hybrid A planner.

15. The computer-implemented method for deadlock recovery of claim 11, wherein one or more of the STL rules includes a spatial constraint, a traffic rule, or a hardware constraint associated with the AV.

16. An autonomous vehicle (AV) capable of deadlock recovery, comprising:
a memory storing one or more instructions;
a processor executing one or more of the instructions stored on the memory to perform:
generating an initial path for an autonomous vehicle (AV) based on lane information, traffic information, and spatial constraints; and
generating a signal temporal logic (STL) evaluation based on one or more STL rules; and
a Model Predictive Path Integral (MPPI) controller:
generating an AV command based on the initial path, the STL evaluation, and a MPPI cost function; and
operating the AV in an autonomous mode according to the AV command.

17. The AV capable of deadlock recovery of claim 16, wherein the generating the initial path, the generating the STL evaluation, and the generating the AV command is responsive to detecting a deadlock condition.

18. The AV capable of deadlock recovery of claim 16, wherein the generating the initial path is performed by a hybrid A planner.

19. The AV capable of deadlock recovery of claim 16, wherein one or more of the STL rules includes a spatial constraint, a traffic rule, or a hardware constraint associated with the AV.

20. The AV capable of deadlock recovery of claim 16, wherein one or more of the STL rules includes a following distance, a lane keeping rule, a lane change rule, an intersection approach rule, a deadlock timeout rule, or a jerk rule.
